(19) United States
(12) Patent Application Publication
(10) Pub. No.: US 2022/0235836 A1
(43) Pub. Date: Jul. 28, 2022

(54) METHOD FOR PRODUCING A GRAY CAST IRON BRAKE DISK

(71) Applicant: Ford Global Technologies, LLC, Dearborn, MI (US)

(72) Inventors: Klaus Kaesgen, Cologne (DE); Marc Oliver Rettig, Köln (DE); Clemens Maria Verpoort, Monheim am Rhein (DE)

(73) Assignee: Ford Global Technologies, LLC, Dearborn, MI (US)

(21) Appl. No.: 17/578,024

(22) Filed: Jan. 18, 2022

(30) Foreign Application Priority Data
Jan. 15, 2021 (EP) 21151861.8

(51) Int. Cl. F16D 65/12

(52) U.S. Cl. CPC F16D 65/125; F16D 65/127; F16D 2200/0013; F16D 2250/0076; F16D 2250/0046; F16D 2250/0023; F16D 2200/0052

(57) ABSTRACT

A brake disk, the main body of which has been produced from gray cast iron, is coated on its annular brake surfaces with a metallic coating by way of laser deposition welding. In the coating, which includes a welding material with an austenitic structure or at least structural components, a state of internal compressive stress is set by plastic deformation which affects the external outer layer thereof and in one form is performed by a rolling tool.

### CROSS-REFERENCE TO RELATED APPLICATIONS

This application claims priority to and the benefit of European Patent Application No. 21151861.8, filed on Jan. 15, 2021. The disclosure of the above application is incorporated herein by reference.

### FIELD

The disclosure relates to a method for producing a brake disk.

### BACKGROUND

The statements in this section merely provide background information related to the present disclosure and may not constitute prior art.

CN 107 326 221 A discloses a cobalt-based alloy and a cladding layer produced from the cobalt-based alloy. The cobalt-based alloy comprises Co, Ni, Cr, Fe, Si, W, C and Al. The cobalt-based alloy is produced in particular, with respect to the weight, from 19-22.5% Ni, 18-19.5% Cr, 7.5-10.5% Al, 0.8-1.1% Fe, 0.7-1.0% Si, 3.0-4.4% W, 0.6-0.9% C, and the remainder Co and less than 0.1% of unavoidable impurities. The proportion by mass of Ni and Co is greater than 0.4, but less than 0.56, and the proportion by mass of Ni and Al is greater than 2, but less than 2.7. The cobalt-based alloy may be used for producing the cladding layer with high wear resistance and thermal fatigue strength. The cladding layer can be used not only for repairing and improving a friction layer of a brake disk, but also be used as a friction layer of the brake disk and as a protective layer on the surface of other metal materials that have to withstand repeated heat exposure and frictional wear in environments such as mold-cavity liners, engine pistons and internal cylinders, inner walls of oil pipeline valves.

U.S. Publication No. 2020/0191215 A1 discloses a brake disk which is coated in a braking region with a nitrate-containing wear and corrosion protection layer, and otherwise consists of gray cast iron, and a method for its production. The coating is applied in a thermal spraying process, an iron powder being applied in a reducing atmosphere and this layer being nitrided and burnished. To increase the strength, the coating material may contain Cr, Al, Ti and V as nitride formers. By applying pressure during the burnishing, pores between the particles of the iron powder are to be reduced and the density of the coating increased. In this way, the wear, fatigue, and corrosion resistance are to be improved. During the cooling of the applied protective layer, however, internal tensile stresses may occur in it, causing the occurrence of surface cracks and with a detrimental effect on the fatigue characteristics. Said internal stresses may also penetrate into the structure of the gray cast iron of the brake disk and adversely influence its strength properties.

U.S. Publication No. 2010/0173172 A1 discloses a method for producing a wear-reducing, Ni and/or Co containing coating on a metallic substrate, a metallic alloy that forms the coating being applied to the substrate and hardened after roughening. The hardening is carried out by means of plastic deformation by rolling, the application of the alloy in powder form being carried out for example as part of a laser deposition welding process. As a result of the hardening based on plastic deformation, the coating is characterized by internal compressive stresses, by which the resistance to tensile loads, the fatigue strength and the corrosion resistance of the coating are improved. The disclosure content of this document is incidentally restricted to general information, not pertaining to any specific substrate.

DE 10 2011 089 848 A1 discloses a further method for producing a gray cast iron brake disk, the annular friction surface of which is coated with a wear-reducing coating. Before the coating is applied, a treatment of the brake disk takes place for the purpose of setting an internal compressive stress in the surface or friction surface before the coating is applied after a smoothing operation. The coating is applied in a thermal spraying process and contains carbides, for example chromium and/or tungsten carbides, which are incorporated in a nickel- or cobalt-based metallic matrix. Internal compressive stresses in the surface region of the brake-disk main body are achieved by means of a plastic deformation by means of a rolling tool, notches being closed, and crack formation counteracted by the subsequent smoothing. Corrosion-induced cracks are also intended to be avoided in this way. However, an occurrence of internal tensile stresses and cracks cannot be ruled out in the subsequently applied coating after it has cooled down.

Of the thermal methods that are available overall for applying a protective coating in the case of brake disks, laser deposition welding (laser cladding) has proven to be particularly advantageous, specifically in particular with regard to the achievable corrosion resistance. However, once cooling down has taken place, internal tensile stresses and cracks can form, affecting the strength and fatigue characteristics of the brake disk.

### SUMMARY

This section provides a general summary of the disclosure and is not a comprehensive disclosure of its full scope or all of its features.

In one form of the present disclosure, a method of producing a brake disk with a disk-like main body of gray cast iron and at least one annular brake surface includes applying a coating to the at least one annular brake surface by laser cladding, and working a surface of the coating such that at least an outer part of the coating is plastically deformed and internal compressive stresses are set. The coating is a welding material with an austenitic structure.

In another form of the present disclosure, a brake disk includes a disk-like main body having at least one annular brake surface and a coating on the at least one annular brake surface. The coating is applied by laser cladding. At least an outer layer of the coating is plastically deformed.

In yet another form of the present disclosure, a method of producing a brake disk with a disk-like main body of gray cast iron and at least one annular brake surface includes applying a coating to the at least one annular brake surface by laser cladding, and working a surface of the coating such that at least an outer part of the coating is plastically deformed and internal compressive stresses are set. The coating has a bonding layer and a top layer. The top layers are a welding material with an austenitic structure.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

The present disclosure provides a method for producing a brake disk comprising a disk-like main body consisting of gray cast iron, the at least one annular friction or brake surface of which is covered with a coating serving for wear and/or corrosion protection, the coating being applied by way of laser deposition welding. According to the disclosure, a welding material with an austenitic structure or structural components is used when carrying out the coating, plastic deformation being used to set internal compressive stresses in at least an outer layer that is facing a free surface of the coating.

An externally applied compaction of an outer layer of the coating is brought about by plastic deformation, which leads to the formation of internal compressive stresses at this location. These stresses improve the capability of absorbing loads in the form of tensile stresses and counteract the production of cracks. The internal compressive stresses also help decrease the chance of pre-existing cracks from spreading because of material fatigue and in particular inhibit cracks spreading into the structure of the gray cast iron main body of the brake disk. In the region influenced by the deformation, any pores that are possibly present can also be closed again. A reduction of cracks and pores and accompanying surface smoothing also contribute to improved protection from ingress of corrosively acting rainwater or the like into the substance of the gray cast iron of the brake disk. The fact that the welding material of the coating applied by laser deposition welding has an austenitic structure or austenitic structural components means that its deformation involves strong work hardening, which leads to a considerable increase in the yield strength. The setting of internal compressive stresses by plastic deformation together with the use of an austenitic structure consequently brings with it not only an improvement in strength properties and lifetime but also already improved corrosion protection.

It is included within the scope of the disclosure that both sides of the brake disk have said friction or brake surface, the coating of which has been applied by the method according to the disclosure. The brake disk may of course also be designed as an internally ventilated brake disk. To this extent, the subject matter of the disclosure comprises any brake disks, for example as used on motor vehicles, without this being intended to have any restrictive effect.

In one form of the disclosure, it may be envisaged to make the coating single-layered or multi-layered. In the case of the single-layered coating, the coating is applied directly to the substance of the gray cast iron. This is possible if the coating is compatible with the substance of the gray cast iron. If the coating is made multi-layered, first a bonding-agent layer may be applied to the substance of the gray cast iron, and then a top layer is applied to that. The bonding-agent layer may be a high-grade steel with the material number 1.4401, 1.4462 or 1.4465, which of course is not intended to be restrictive. On the bonding-agent layer, the top layer with an austenitic structure or structural components is then applied.

In some forms of the method, it may be provided that, when carrying out the coating, a welding material with carbides or carbide mixtures may be used, both in the case of the single-layered coating and in the case of the multi-layered coating. In particular, in the case of the multi-layered coating, in some forms, only the top layer is applied with an austenitic structure or structural components with carbides or carbide mixtures, while the bonding-agent layer may be formed by said high-grade steels. The top layer in one form of the present disclosure is formed from austenitic steels such as for example 1.4401, 1.4462 or 1.4462, but with hard carbide particles as reinforcement against wear. Consequently, when carrying out the coating, therefore a welding material with carbides or carbide mixtures that contribute to increasing the strength are used. In this way, an increase in the hardness and the corrosion resistance can also be obtained, as well as a further reduction in wear.

Very fine carbides of a size of 1-5 μm may be used, but also carbides of 40-70 μm (for example Cr, Ti, V and niobium carbide).

In one form, the outer layer of the coating is completely plastically deformed, which may be provided in the case of the single-layered coating, but also in the case of the multi-layered coating. In some forms, if the coating is made multi-layered, only the top layer with an austenitic structure or structural components with carbides or carbide mixtures may be plastically deformed. It can consequently be provided that the plastic deformation of the coating is restricted to an external outer layer that is facing a free surface, that is, only to the top layer, part thereof or only part of the single-layered coating. Plastic deformation of only the top layer in the case of the multi-layered coating or the plastic deformation of only part of the single-layered coating, has been found to be expedient and sufficient in practice.

The layer thickness of the coating may amount to 250-750 μm. However, thinner layers of 150-400 μm are also conceivable. In this case, the top layer in the multi-layered coating is thicker than the bonding-agent layer. In a favorable refinement of the concept according to the disclosure, the bonding-agent layer is applied in a thickness of 50-250 μm, and in another form in a thickness of 120-150 μm. The top layer is applied with a thickness of 200-500 μm, and in one form in a thickness of 100-250 μm.

In another form of the method, the plastic deformation of the outer layer is carried out by a surface-rolling process. This form of the method involves locally exceeding the yield strength of the material and brings about plastic flow of a layer of material near the surface. Apart from smoothing the treated surface, there is increased wear resistance and also an increase in the hardness of the outer layer treated in this way, because of work hardening. Also, welding pores that are possibly present can be eliminated, and the bond between carbides formed from the welding material or carbides separately fed in and the austenitic matrix can be improved. This also results in a reduction in the production costs in comparison with previously known methods, by making it possible to reduce the effort required for finishing by grinding, burnishing, or honing. In some forms of the method, the rolling can be integrated both in the honing, preferably flat honing, and in the grinding, preferably by means of grinding wheels, of the coating.

In yet another form of the method, it may be provided that in the plastic deformation rolling tools are used, the effective width of which at least substantially corresponds to the width of the brake surface of the brake disk, preferably is at least as wide as the width of the brake surface, more preferably somewhat greater than the latter, so that the entire coating can be rolled, that is to say rolled smooth. This makes efficient working possible, since the entire width of the covering of welding material forming the coating can be treated at the same time, and consequently uniformly. Rolling tools are known per se in various forms and are often mounted in a multiple arrangement on tool heads.

Altogether, the method according to the disclosure provides a method which makes it possible to produce a brake disk with improved wear and strength properties, in particular concerning its lifetime, the brake surface of which requires less effort for reworking in comparison with the prior art and which in addition has an increased resistance to corrosion.

It should be pointed out that the features listed in the claims can be combined with one another in any, technically meaningful way and show further refinements of the disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for producing a brake disk, the brake disk having a disk-like main body of gray cast iron, the disk-like main body having at least one annular brake surface, the method comprising:
applying a coating to the at least one annular brake surface by laser cladding, the coating being a welding material with an austenitic structure; and
working a surface of the coating such that at least an outer part of the coating is plastically deformed and internal compressive stresses are set.

2. The method according to claim 1, wherein the welding material includes carbides or carbide mixtures.

3. The method according to claim 1, wherein the coating is completely or partially plastically deformed.

4. The method according to claim 1, wherein the coating is applied in a single-layered or multi-layered form.

5. The method according to claim 4, wherein the multi-layered coating is applied with a bonding-agent layer and with a top layer.

6. The method according to claim 5, wherein only the top layer is plastically deformed.

7. The method according to claim 1, wherein the plastic deformation is carried out by a surface-rolling process.

8. The method according to claim 7, wherein the plastic deformation is carried out by rolling tools, the rolling tools having a width effective for the plastic deformation at least substantially corresponding to the width of the brake surface.

9. A brake disk comprising:
a disk-like main body having at least one annular brake surface; and
a coating on the at least one annular brake surface, the coating applied by laser cladding, at least an outer layer of the coating being plastically deformed by the laser cladding such that internal compressive stresses are set.

10. The brake disk according to claim 9, wherein the coating is a welding material having an austenitic structure.

11. The brake disk according to claim 9, wherein the coating includes carbides or carbide mixtures.

12. The brake disk according to claim 9, wherein the coating is completely or partially plastically deformed.

13. The brake disk according to claim 9, wherein the plastic deformation is carried out by a surface-rolling process.

14. The brake disk of claim 9, wherein the plastic deformation is carried out by rolling tools, the rolling tools having a width effective for the plastic deformation at least substantially corresponding to the width of the brake surface.

15. A method for producing a brake disk, the brake disk having a disk-like main body of gray cast iron, the disk-like main body having at least one annular brake surface, the method comprising;
applying a coating to the at least one annular brake surface by laser cladding, the coating having a bonding layer and a top layer, the top layer being a welding material with an austenitic structure; and
working a surface of the coating such that at least an outer part of the coating is plastically deformed and internal compressive stresses are set.

16. The method according to claim 15, wherein the welding material includes carbides or carbide mixtures.

17. The method according to claim 15, wherein the coating is completely or partially plastically deformed.

18. The method according to claim 15, wherein only the top layer is plastically deformed.

19. The method according to claim 15, wherein the plastic deformation is carried out by a surface-rolling process.

20. The method according to claim 15, wherein the plastic deformation is carried out by rolling tools, the rolling tools having a width effective for the plastic deformation at least substantially corresponding to the width of the brake surface.
